(19) United States
(12) Patent Application Publication
(10) Pub. No.: US 2004/0130697 A1
(43) Pub. Date: Jul. 8, 2004

(54) Reflection preventing film modifying apparatus and reflection preventing film modifying method

(75) Inventor: Masayoshi Kobayashi, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/738,908

(22) Filed: Dec. 16, 2003

(30) Foreign Application Priority Data
Dec. 19, 2002 (JP) 2002-368583

(51) Int. Cl. G03B 27/58

(52) U.S. Cl. 355/72; 430/438; 355/75

(57) ABSTRACT

An apparatus for selectively modifying a reflection preventing film formed on a substrate to change the optical characteristic of a region in the reflection preventing film. The apparatus includes: a substrate holding mechanism; a modifying light irradiating mechanism; and a processing position changing mechanism configured to change a processing position of the modifying light on the substrate by changing a relative position between an irradiation position of the modifying light and the substrate held by the substrate holding mechanism.

### BACKGROUND OF THE INVENTION

1. Field of the Invention

The present invention relates to a reflection preventing film modifying apparatus and a reflection preventing film modifying method for modifying a predetermined region in a reflection preventing film beneath a photosensitive film formed on a substrate and thereby changing an optical characteristic of the predetermined region. The substrate to be processed includes various kinds of substrates to which the photolithographic technique is applicable, such as a semiconductor wafer, a glass substrate for a liquid crystal display, and a glass substrate for a plasma display panel.

2. Description of Related Art

In a fabrication sequence of a semiconductor device, the photolithographic process is performed repetitively with respect to a semiconductor wafer (hereinafter, referred to simply as the wafer). The photolithographic process includes a step of applying and forming a photoresist film on the surface of the semiconductor substrate, a step of exposing the photoresist film to a specific pattern through the use of a photomask called a reticle, and a step of developing and thereby patterning the exposed photoresist film into a desired pattern. Because of the need for micro-fabrication, an exposing apparatus having a high resolution called a stepper is used in the fabrication sequence of the semiconductor device.

During the fabrication sequence of the semiconductor device, patterns are superimposed in many layers to form a single circuit, and for this reason, the stepper is furnished with an alignment function for a layer to be exposed and an underlying layer. To be more specific, the pattern on each layer formed on the semiconductor substrate is provided with alignment marks used for alignment with the pattern on a layer on the top. The stepper is provided with an optical system used to observe the alignment marks, and the reticle is aligned with the alignment marks based on the position information of the underlying layer obtained by measuring the positions of the alignment marks.

As a more miniaturized pattern is being formed, instability of the line width caused by an interference effect in the photoresist film raises a problem. Accordingly, a reflection preventing film has been applied beneath the photoresist film recently. The reflection preventing film is designed to prevent reflection of light with a wavelength (exposure wavelength) used in the exposing step, and thereby prevents interference from occurring in the photoresist film.

The presence of the reflection preventing film, however, makes it impossible to observe the alignment marks on the layer beneath through the use of light with an exposure wavelength. Hence, alignment has to be performed through the use of light with a wavelength other than the exposure wavelength. To be more specific, the wafer and the reticle are aligned by measuring the alignment mark positions through the use of light with a wavelength other than the exposure wavelength by an optical system different from an image forming lens used in forming an image of exposure light on the substrate.

However, because the alignment mark positions are measured by the optical system different from the optical system used for exposure, the stage holding the wafer has to be moved to a position at which the alignment marks match with the reticle after the alignment mark positions are measured. Hence, alignment with satisfactory accuracy is not necessarily achieved.

On the other hand, when the alignment marks and the reticle are aligned by observing the alignment marks on the wafer through the use of light with the same wavelength as that of the exposure light through an image forming lens used for exposure, the wafer and the reticle can be readily brought into an exact matching state. This makes highly accurate alignment possible, which in turn enables micro-fabrication of a high quality. Hence, in order to achieve micro-fabrication of high accuracy, it is essential to perform alignment with the use of light with an exposure wavelength by removing the reflection preventing film above the alignment marks.

One of the methods for selectively removing the reflection preventing film above the alignment marks is the photolithographic process, which, however, has problems in that not only the process cost is high, but also the processing takes a long time.

Under these circumstances, there has been recently proposed a method of selectively removing the reflection preventing film above the alignment marks by exploiting the laser abrasion phenomenon (see Japanese Laid-Open Patent Application No. 113779/1998). This method, however, has problems in that not only unwanted particles are generated when materials of the reflection preventing film evaporate explosively through the laser abrasion phenomenon, but also heat generated during processing gives adverse effects to the device.

### SUMMARY OF THE INVENTION

It is therefore an object of the invention to provide a reflection preventing film modifying apparatus and a reflection preventing film modifying method, capable of achieving advantages equivalent to those achieved by selectively removing the reflection preventing film, through inexpensive and short-time processing without generating particles.

A reflection preventing film modifying apparatus of the invention is a reflection preventing film modifying apparatus for performing processing with respect to a substrate on which is formed a reflection preventing film preventing reflection of light within a particular wavelength range to change an optical characteristic of a predetermined region to be processed in the reflection preventing film by selectively modifying the region to be processed in the reflection preventing film. The reflection preventing film modifying apparatus includes: a substrate holding mechanism configured to hold a substrate to be processed; a modifying light irradiating mechanism configured to irradiate modifying light capable of modifying the reflection preventing film toward the substrate held by the substrate holding mechanism; and a processing position changing mechanism configured to change a processing position of the modifying light on the substrate by changing a relative position between an irradiation position of the modifying light from the modifying light irradiating mechanism and the substrate held by the substrate holding mechanism.

According to this arrangement, the modifying light is irradiated toward the substrate from the modifying light irradiating mechanism while the substrate to be processed is held by the substrate holding mechanism and the relative position between the irradiation position of the modifying light from the modifying light irradiating mechanism and the substrate held by the substrate holding mechanism is determined adequately by the processing position changing mechanism. It is thus possible to change the optical characteristic of the region to be processed in the reflection preventing film formed on the substrate by modifying the region to be processed. Consequently, the optical characteristic of the region to be processed in the reflection preventing film is changed to reflect light within the particular wavelength range (light having a wavelength within the particular wavelength range) Hence, the pattern (for example, alignment marks) formed beneath the reflection preventing film can be observed through the use of light within the particular wavelength range.

In this manner, advantages equivalent to those achieved by selectively removing the reflection preventing film can be achieved through inexpensive and short-time processing in comparison with the photolithographic processing. Moreover, different from the case of selectively removing the reflection preventing film through the laser abrasion phenomenon, the reflection preventing film is only modified partially, which prevents unwanted particles from being generated.

The substrate holding mechanism may include a stage on which the substrate is placed horizontally or nearly horizontally. In this case, the processing position changing mechanism may be a stage moving mechanism that displaces the stage in two horizontal directions (preferably, two directions intersecting at right angles with each other).

Also, while the substrate is held in a stationary state by the substrate holding mechanism, the processing position changing mechanism may comprise a scanning mechanism configured to scan the substrate with light irradiated from the modifying light irradiating mechanism with the use of a two-dimensional scanning optical system, such as a galvanometer mirror. In addition, the relative position between the irradiation position of the modifying light and the substrate may be varied by moving the substrate holding mechanism while changing the irradiation position of the modifying light from the modifying light irradiating mechanism.

The modifying light from the modifying light irradiating mechanism may include light within one or two or more wavelength ranges selected from ranges of infrared light, visible light, and ultraviolet light. Also, the modifying light may include light within the exposure wavelength range. The modifying light may comprise only light within the particular wavelength range to prevent reflection from the reflection preventing film, or light within a broad wavelength range including light within the particular wavelength range. As a light source generating such modifying light, a discharge lamp or a laser apparatus may be equipped to the modifying light irradiating mechanism.

The modifying light irradiating mechanism may comprise a light source and an aperture having an opening portion, so that an irradiation region of the modifying light is limited by irradiating light from the light source to the aperture and projecting an image of the opening portion of the aperture onto the substrate with the use of an optical system. In this case, it is preferable that the size or the shape of the opening portion of the aperture can be changed under control. Further, it is preferable that the light source generates light having homogenous power inside the opening portion of the aperture. This makes it possible to modify a reflection preventing film homogeneously in the region where the modifying light is irradiated on the substrate.

On the substrate, a photosensitive film (for example, a photoresist film) to be exposed to light within the particular wavelength range may have been formed on the reflection preventing film, or the photosensitive film may be formed on the reflection preventing film after the reflection preventing film was selectively modified.

The reflection preventing film modifying apparatus of the invention may be incorporated into a reflection preventing film applying apparatus, a photosensitive film applying apparatus, or an exposing apparatus used to expose the photosensitive film, or alternatively, it may comprise an independent apparatus different from these apparatuses.

The substrate to be processed may be provided with alignment marks on the underlying layer of the reflection protecting film. The alignment marks are used for alignment between an exposure mask used when a photosensitive film formed on the reflection preventing film is exposed to a specific pattern through the use of light within the particular wavelength range and the substrate. In this case, it is preferable that the reflection preventing film modifying apparatus further includes a modifying position control apparatus that controls the processing position changing mechanism, so that the irradiation position of the modifying light from the modifying light irradiating mechanism is matched with the region to be processed that encompasses the alignment marks.

According to this arrangement, because the irradiation position of the modifying light from the modifying light irradiating mechanism is matched with the region to be processed that encompasses the alignment marks, it is possible to modify the reflection preventing film above the alignment marks, and the optical characteristic of the region to be processed can be thereby changed. It is thus possible to match the alignment marks with the exposure mask (reticle) at high accuracy by observing the alignment marks through the use of light within the particular wavelength range when the photosensitive film is exposed through the use of light within the particular wavelength range.

Also, the reflection preventing film modifying apparatus may further include an alignment mark position measuring mechanism configured to measure positions of the respective alignment marks provided to the substrate held by the substrate holding mechanism through the use of light within a wavelength range other than the particular wavelength range. In this case, it is preferable that the modifying position control apparatus controls the processing position changing mechanism based on a measuring result from the alignment mark position measuring mechanism.

According to this arrangement, the positions of the alignment marks are measured through the use of light within a wavelength range other than the particular wavelength range, and the irradiation position of the modifying light is matched with the alignment marks based on the measuring result. It is difficult to observe the alignment marks through the use of light within the particular wavelength range before the reflection preventing film is modified; however, through the use of light within a wavelength range other than the particular wavelength range, the positions of the alignment marks can be measured exactly. It is thus possible to change the optical characteristic of the region to be processed in the reflection preventing film by defining a region in the vicinity of the alignment marks as the region to be processed.

Instead of measuring the positions of the alignment marks, the position information of the alignment marks may be pre-registered in a memory, so that the processing position changing mechanism is controlled based on the position information of the alignment marks registered in the memory.

Further, the reflection preventing film modifying apparatus may further include: an accumulated light quantity measuring mechanism configured to measure an accumulated quantity of light as to the modifying light irradiated to the substrate to be processed from the modifying light irradiating mechanism; and a modifying light irradiation control apparatus configured to keep irradiating the modifying light from the modifying light irradiating mechanism toward the substrate until the accumulated quantity of light measured by the accumulated light quantity measuring mechanism reaches a predetermined quantity.

According to this arrangement, when an accumulated quantity of light since the irradiation of the modifying light from the modifying light irradiating mechanism to the substrate to be processed has started reaches the predetermined quantity, irradiation of the modifying light from the modifying light irradiating mechanism to the substrate is stopped. Hence, by setting a value of the predetermined quantity, at which the contrast of an image to be observed takes the maximal (or local maximal) value, when the irradiation region of the modifying light is observed through the use of light within the particular wavelength, the reflection preventing film can be modified quite effectively.

The researches by the inventor of the present application have revealed that the contrast shows a sinusoidal change with an increase of an accumulated quantity of light in the initial stage of the modification of the reflection preventing film, that is, in the stage at which an accumulated quantity of light is satisfactory small in comparison with a quantity of light at which the modification saturates. Hence, by empirically finding an accumulated quantity of light at which the contrast becomes maximal (or local maximal) in advance to be stored into the memory, and by stopping irradiation of the modifying light from the modifying light irradiating mechanism under control based on the predetermined quantity of light thus stored in the memory, the reflection preventing film can be modified effectively.

For example, the modifying light irradiating mechanism may be provided with a light source, and a shutter blocking an optical path of the irradiated light introduced from the light source to the substrate to be processed, so that irradiation of the modifying light is stopped by closing the shutter when an accumulated quantity of light measured by the accumulated light quantity measuring mechanism reaches the predetermined quantity.

In a case where the modifying light irradiating mechanism irradiates the modifying light of a constant quantity of light per unit time, the accumulated light quantity measuring mechanism may measure a time since irradiation of the modifying light to the substrate to be processed has started.

The reflection preventing film modifying apparatus may further include: an observation optical system used to observe an irradiation region of the modifying light through the use of light within the particular wavelength range; an image pick-up apparatus configured to detect an image to be observed through the observation optical system; and a modifying light irradiation control apparatus configured to control irradiation of the modifying light by the modifying light irradiating mechanism based on an output signal from the image pick-up apparatus.

According to this arrangement, the irradiation region of the modifying light is observed through the use of light within the particular wavelength range, and the observing result is outputted from the image pick-up apparatus in the form of an electrical signal. It is thus possible to adequately determine the timing at which irradiation of the modifying light should be stopped depending on how the modification is proceeding.

To be more specific, it is preferable that the reflection preventing film modifying apparatus further includes a contrast detecting circuit configured to detect contrast of an image obtained by the image pick-up apparatus. In this case, it is preferable that the modifying light irradiation control apparatus keeps irradiating the modifying light from the modifying light irradiating mechanism toward the substrate until one of the following: until the contrast detected by the contrast detecting circuit reaches a maximal (or local maximal) value; and until a time at which the contrast detected by the contrast detecting circuit is predicted to reach the maximal (or local maximal) value. Consequently, irradiation of the modifying light can be stopped at the timing at which the contrast of an image to be observed becomes maximal (or local maximal) while the irradiation region of the modifying light is being monitored through the use of light within the particular wavelength range. Hence, the reflection preventing film can be modified effectively.

As has been described, because the contrast is known to change in the shape of a sine wave with an increase of an accumulated quantity of light as to the modifying light, a time at which the contrast reaches the maximal (or local maximal) value may be predicted from the manner in which the contrast changes, so that the irradiation of the modifying light is stopped at the time thus predicted.

The image pick-up apparatus may be an apparatus including a one-dimensional image sensor or a two-dimensional image sensor.

A reflection preventing film modifying method of the invention irradiates, to a predetermined region to be processed of a substrate on which is formed a reflection preventing film preventing reflection of light within a particular wavelength range, modifying light capable of modifying the reflection preventing film, and thereby selectively changes an optical characteristic of the region to be processed in the reflection preventing film.

In this method, it is preferable to measure an accumulated quantity of light as to the modifying light irradiated to the region to be processed, and the modifying light is kept irradiated to the region to be processed until the accumulated quantity of light reaches a predetermined quantity.

Also, an observation optical system used to observe the region to be processed through the use of light within the particular wavelength range may be provided, so that an image to be observed through the observation optical system may be detected by an image pick-up apparatus, and the modifying light may be kept irradiated to the region to be processed until one of the following: until contrast of an image detected by the image pick-up apparatus reaches a maximal (or local maximal) value; and until a time at which the contrast is predicted to reach the maximal (or local maximal) value.

The above and other objects, features, and advantages of the invention will become more apparent from the following description of embodiments with reference to the accompanying drawings.

### BRIEF DESCRIPTION OF THE DRAWINGS

FIG. 1(a), FIG. 1(b), and FIG. 1(c) are schematic diagrams used to explain reflection preventing film modifying processing according one embodiment of the invention;

FIG. 2 is a view showing a relation between the contrast when an image in the vicinity of alignment marks is picked up through the use of light within an exposure wavelength range and an accumulated quantity of light as to modifying light irradiated to a reflection preventing film;

FIG. 3 is a conceptual view showing a configuration of a reflection preventing film modifying apparatus according to a first embodiment of the invention;

FIG. 4 is a conceptual view used to explain a configuration of a reflection preventing film modifying apparatus according to a second embodiment of the invention; and

FIG. 5(a) through FIG. 5(d) are views used to explain the usages of the reflection preventing film modifying apparatus according to the first or second embodiment.

### DESCRIPTION OF THE PREFERRED EMBODIMENTS

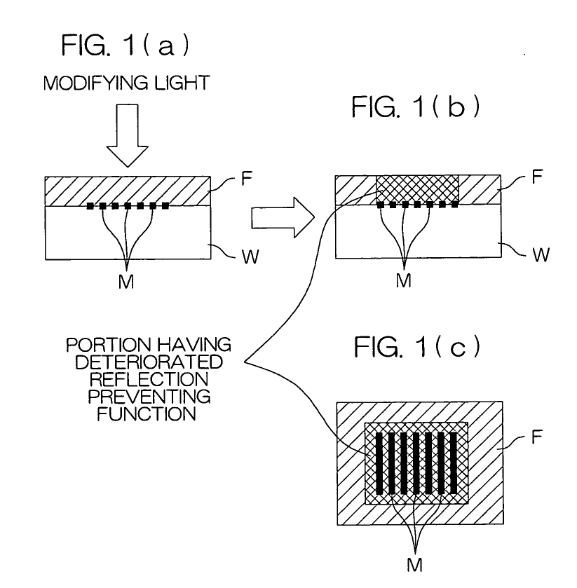

FIG. 1(a), FIG. 1(b), and FIG. 1(c) are schematic diagrams used to explain reflection preventing film modifying processing according one embodiment of the invention. Patterns are superimposed in many layers on the surface of a substrate W, such as a semiconductor wafer, and alignment marks M are formed on the pattern on each layer in a predetermined region. The alignment marks M are formed, for example, at ten or more points in each layer.

Each alignment mark M is made of, for example, a pattern of a plurality of parallel straight lines. In order to form another pattern, being superimposed on the pattern having the alignment marks M formed thereon, a reflection preventing film F is formed to cover the alignment marks M, and further, an applied film of photoresist (not shown) is formed on the reflection preventing film F.

As shown in the cross section of FIG. 1(a), by selectively irradiating modifying light on a region where the alignment marks M have been formed, then as shown in the cross section of FIG. 1(b) and the plan view of FIG. 1(c), the reflection preventing film F is modified in the region where the modifying light was irradiated, and the optical characteristic (optical constant, in particular, refractive index) is thereby changed. In other words, it is now possible to observe the alignment marks M beneath the modified region with satisfactory contrast through the use of light within an exposure wavelength range (for example, 248 nm in the case of exposure by a KrF stepper) used in exposing the photoresist to be formed on the reflection preventing film.

The modifying light is preferably light within an ultraviolet wavelength range, but it may be visible light or infrared light. The modifying light is not necessarily the light with a single wavelength, and two or more kinds of light selected from infrared light, visible light, and ultraviolet light may be mixed to be used as the modifying light. Further, the modifying light may include light within the exposure wavelength range for exposing the photoresist film to be formed on the reflection preventing film F.

The reflection preventing film F in the region above the alignment marks M may be modified either before or after the photoresist film is formed. Because the alignment marks M are formed in the region avoiding the pattern to be formed on the substrate W, even when light within the exposure wavelength range is irradiated to a region in the vicinity of the alignment marks M after the photoresist film is applied, the circuit pattern can be formed without being affected.

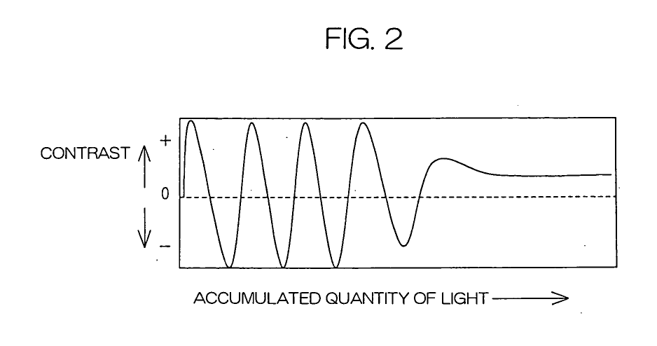

FIG. 2 is a view showing a relation between the contrast when an image in the vicinity of the alignment marks M is picked up through the use of light within the exposure wavelength range, that is, light within a wavelength range that is not reflected from the non-modified reflection preventing film F, and an accumulated quantity of light as to the modifying light irradiated to the reflection preventing film F. As can be understood from FIG. 2, the contrast varies in the shape of a sine wave with an increase of the accumulated quantity of light, and the contrast stays at almost a constant value when the reflection preventing film F is fully modified. Hence, by empirically finding the accumulated quantity of light at which the contrast reaches a positive or negative maximal or local maximal value (the value at which the absolute value is maximal or local maximal) in advance, and by irradiating the modifying light to the reflection preventing film F up to the accumulated quantity of light thus found, it is possible to bring the optical characteristic of the reflection preventing film F into a state suitable for observation through the use of light within the exposure wavelength range.

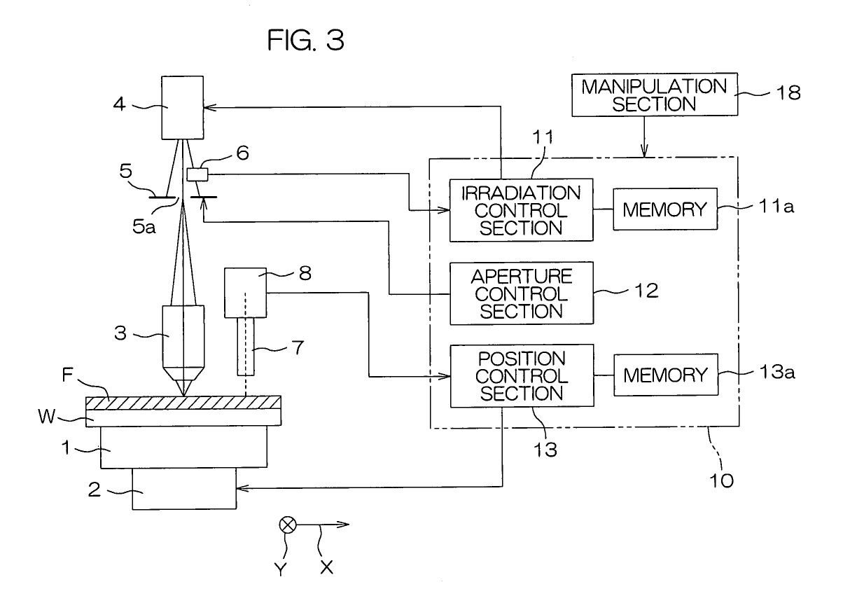

FIG. 3 is a conceptual view showing a configuration of a reflection preventing film modifying apparatus according to a first embodiment of the invention. The substrate W to be processed, on which the reflection preventing film F has been formed, is placed on a horizontal top surface of a stage 1 used as a substrate holding mechanism, and is held thereon, for example, through suction. The stage 1 is configured to move horizontally along two horizontal directions X and Y, which intersect at right angles with each other, by an XY driving mechanism 2. An image forming optical system (reducing optical system) 3 is provided oppositely to the substrate W held on the stage 1, and light generated from a modifying-light light source 4 comprising, for example, a discharge tube, such as a mercury lamp and a deuterium lamp, and narrowed by an aperture 5 is incident on the image forming optical system 3. Hence, light having a cross section corresponding to the shape of an opening portion 5a of the aperture 5 forms an image on the reflection preventing film F on the surface of the substrate W with the use of the image forming optical system 3.

The aperture 5 is configured to change the size and the shape of the opening portion 5a, and a driving mechanism (not shown) used to change the shape and the size of the opening portion 5a is controlled by a control apparatus 10 including a microcomputer and the like.

A measuring device 6 of an accumulated quantity of light used to measure an accumulated quantity of light as to the modifying light generated from the modifying-light light source 4 is disposed between the modifying-light light source 4 and the aperture 5.

On the other hand, an alignment optical system 7 used to observe the alignment marks M beneath the reflection preventing film F is provided at a position opposing the surface of the substrate W held on the stage 1. An image on the substrate W is picked up by a CCD camera 8 via the alignment optical system 7. An output signal from the CCD camera 8 is inputted into the control apparatus 10.

The control apparatus 10 includes an irradiation control section 11 that controls the modifying-light light source 4 based on an accumulated quantity of light detected by the measuring device 6 of an accumulated quantity of light, an aperture control section 12 that controls the size and the shape of the opening portion 5a of the aperture 5, and a position control section 13 that controls the XY driving mechanism 2 based on a signal from the CCD camera 8.

The position control section 13 detects the alignment marks M formed beneath the reflection preventing film F based on a signal from the CCD camera 8. Because the alignment optical system 7 is configured to enable observation of the surface of the substrate W using a light source for light with a wavelength unsusceptible to the reflection preventing film F (for example, visible light), the CCD camera 8 can pick up an image of the alignment marks M beneath the reflection preventing film F.

The position control section 13 measures the positions of the alignment marks M provided to the substrate W, by monitoring an output from the CCD camera 8 while moving the stage 1 with the use of the XY driving mechanism 2. Generally, a plurality of alignment marks M are provided to the substrate W, and the positions of the respective alignment marks M are measured. Position information for each alignment mark M is then stored into a memory 13a.

When the position information for all the necessary alignment marks M is stored into the memory 13a, the position control section 13 moves the stage 1 horizontally by controlling the XY driving mechanism 2, and leads the alignment marks M successively to an image forming position of the image forming optical system 3, that is, an irradiation position of the modifying light. Then, while a region to be processed large enough to encompass each alignment mark M is matched with the irradiation position of the modifying light, the modifying-light light source 4 starts to emit light by the action of the irradiation control section 11. Also, the size and the shape of the opening portion 5a of the aperture 5 are changed as needed by the action of the aperture control section 12.

When the modifying-light light source 4 starts to irradiate the modifying light, the measuring device 6 of an accumulated quantity of light starts to accumulate a quantity of light. A value indicting a quantity of light thus accumulated is taken into the irradiation control section 11, and is then compared with a value indicting a predetermined quantity of light pre-stored in a memory 11a. The value indicating the predetermined quantity of light is equal to a value indicting an accumulated quantity of light in a modified state where the contrast reaches the maximal or local maximal value when the alignment marks M are observed through the use of light within the exposure wavelength range used to expose the photoresist film formed on the reflection preventing film F, which has been found empirically in advance and stored in the memory 11a by a manipulation on a manipulation section 18. When an accumulated quantity of light detected by the measuring device 6 of an accumulated quantity of light reaches the value indicating the predetermined quantity of light stored in the memory 11a, the irradiation control section 11 stops the modifying-light light source 4 from emitting light. The reflection preventing film F above the alignment marks M is modified in this manner, and the optical characteristic of the reflection preventing film F is thereby changed.

By furnishing the aperture 5 with a function of a shutter by making the opening portion 5a openable/closable, irradiation of the modifying light can be stopped by closing the opening portion 5a instead of stopping the modifying-light light source 4 from emitting light.

Also, the XY driving mechanism 2 can be omitted, for example, by using a laser light source, such as an ultraviolet laser, as the modifying-light light source 4, and the substrate W is scanned by laser light from this laser light source with the use of a polarizing optical system, such as a two-dimensional galvanometer.

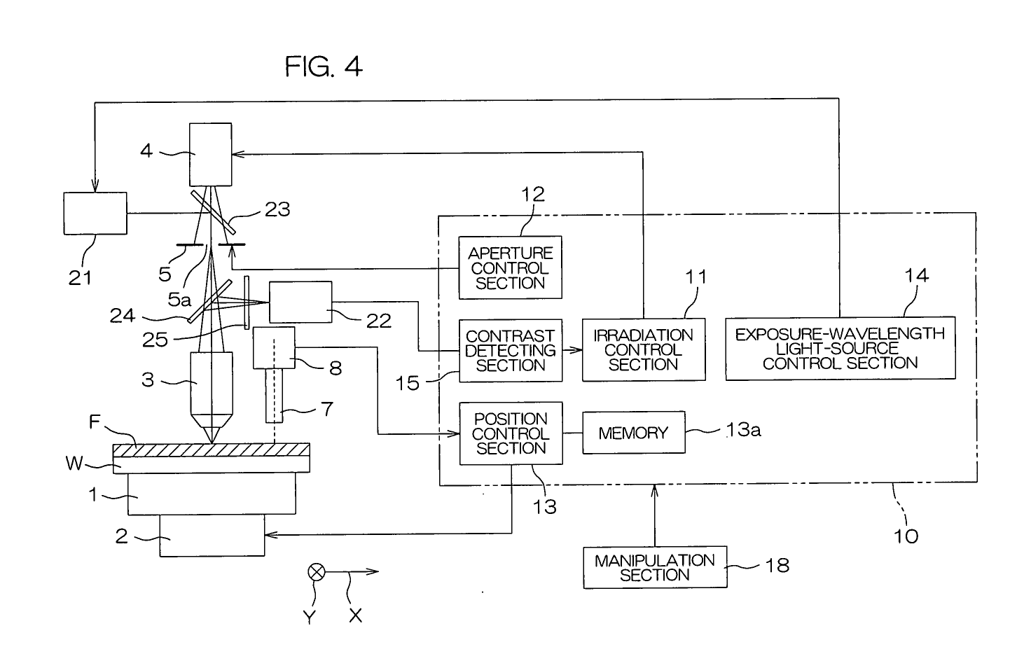

FIG. 4 is a conceptual view used to explain a configuration of a reflection preventing film modifying apparatus according to a second embodiment of the invention. In FIG. 4, portions corresponding to the respective portions shown in FIG. 3 are labeled with the same reference numerals or characters as those in FIG. 3. In this embodiment, an exposure wavelength light source 21 that irradiates light within the exposure wavelength range to an irradiation region of the modifying light on the substrate W, and a camera 22 including a one-dimensional or two-dimensional image pick-up element for detecting an image of light within the exposure wavelength range reflected from the substrate W are additionally provided. An output signal from the camera 22 is inputted into the control apparatus 10.

To be more concrete, a dichroic mirror 23 is interposed between the modifying-light light source 4 and the aperture 5, so that light within the exposure wavelength range from the exposure wavelength light source 21 is incident on the dichroic mirror 23 in a direction intersecting at right angles with an optical axis of the aperture 5. Light from the exposure wavelength light source 21 is thereby reflected from the dichroic mirror 23, introduced to the image forming optical system 3 via the opening portion 5a of the aperture 5, and irradiates the region to be modified on the substrate W.

The dichroic mirror 23 is designed to reflect light within the exposure wavelength range alone, and therefore, the modifying light from the modifying-light light source 4 passes through the dichroic mirror 23 and the opening portion 5a of the aperture 5, and is irradiated to the region to be modified in the reflection preventing film F by the image forming optical system 3.

Further, a half mirror 24 is interposed between the aperture 5 and the image forming optical system 3. The half mirror 24 allows light with an arbitrary wavelength to pass from the aperture 5 side to the image forming optical system 3, while reflecting part of light reflected from the image forming optical system 3 in a direction intersecting at or nearly at the right angles with the optical axis of the image forming optical system 3. Light within the exposure wavelength range, which is reflected from the half mirror 24, is then incident on the camera 22. In order to detect only an image formed by the light within the exposure wavelength range in the camera 22, a band-pass filter 25 that allows the passing of the light within the exposure wavelength range alone is interposed between the half mirror 24 and the camera 22.

The control apparatus 10 is provided with an exposure-wavelength light-source control section 14 in addition to the foregoing irradiation control section 11, aperture control section 12, and position control section 13. When the modifying-light light source 4 generates the modifying light under the control of the irradiation control section 11, the exposure-wavelength light-source control section 14 controls the exposure wavelength light source 21 to generate light with the exposure wavelength.

The control apparatus 10 is further provided with a contrast detecting section 15 that detects contrast in an image based on an image signal from the camera 22. The irradiation control section 11 stops the modifying-light light source 4 from generating the modifying light correspondingly when the contrast detected by the contrast detecting section 15 reaches the maximal or local maximal value (a positive or negative maximal or local maximal value). The exposure-wavelength light-source control section 14 subsequently stops the exposure wavelength light source 21 from generating light.

In a case where, for example, an ultraviolet light source having a large quantity of light is used as the modifying-light light source 4, the reflection preventing film F is modified swiftly, and the reflection preventing film F is further modified since the contrast detected by the contrast detecting section 15 has reached the maximal or local maximal value until the modifying-light light source 4 is stopped from generating the modifying light, which may possibly result in unsatisfactory contrast of an image detected through the use of light within the exposure wavelength range. In such a case, the fact that the contrast shows a sinusoidal change is exploited. That is, the irradiation control section 11 predicts a time at which the contrast would become maximal or local maximal based on the detection result from the contrast detecting section 15, and the modifying-light light source 4 is stopped from generating light at the predicted time.

As has been described, according to this embodiment, the region to be modified can be observed through the use of light within the exposure wavelength range, and not only can the contrast of an observed image be detected, but also the modifying processing for the reflection preventing film F can be stopped at the timing at which the contrast reaches the maximal or local maximal value. Consequently, for example, even when the film thickness or the characteristic with respect to the modifying light of the reflection preventing film F is not uniform in the respective portions of the substrate W, the reflection preventing film F above the alignment marks M scattered across the surface of the substrate W can be modified satisfactorily in each region. The exposing apparatus that performs exposure processing with respect to the photoresist film formed on the reflection preventing film F thus becomes able to observe the alignment marks M in a satisfactory manner through the use of light within the exposure wavelength range.

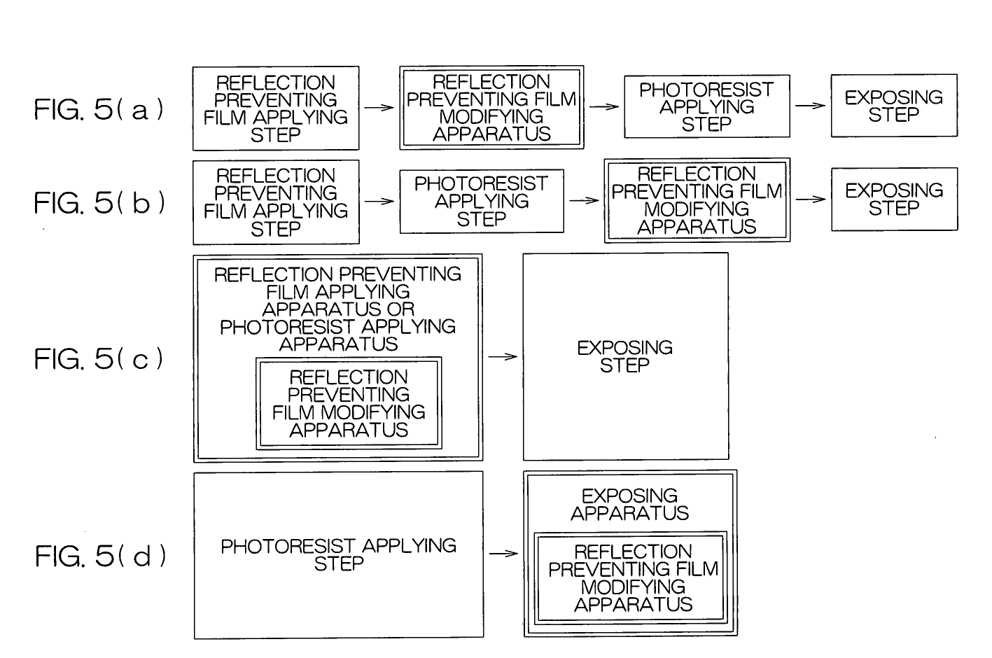

FIG. 5(a) through FIG. 5(d) are views used to explain the usages of the reflection preventing film modifying apparatus according to the first or second embodiment above. As shown in FIG. 5(a), the reflection preventing film modifying apparatus can be used to modify the reflection preventing film F above the alignment marks M between the reflection preventing film forming step of forming the reflection preventing film F on the substrate W, and the photoresist applying step of applying the photoresist on the reflection preventing film F. The alignment marks M and the reticle can be thus aligned at high accuracy in the exposing step subsequent to the photoresist applying step.

Also, as shown in FIG. 5(b), the reflection preventing film F at the region above the alignment marks M may be modified between the photoresist applying step and the exposing step by using the reflection preventing film modifying apparatus.

Further, as shown in FIG. 5(c), the reflection preventing film modifying apparatus may be incorporated into a reflection preventing film applying apparatus or a photoresist applying apparatus.

Furthermore, as shown in FIG. 5(d), the reflection preventing film modifying apparatus may be incorporated into an exposing apparatus (in particular, a stepper) used in the exposing step subsequent to the photoresist applying step.

While the invention has been described by way of two embodiments, the invention can be implemented in another embodiment. For example, the positions of the alignment marks provided onto the substrate W are measured and the measuring result is written into the memory 13a in the embodiments above; however, the position information of the alignment marks on the substrate W may be pre-registered in the memory 13a through the manipulation section 18.

Also, it should be appreciated that the design can be modified in various manners within the scope of the appended claims.

While the above description described embodiments of the invention in detail, it should be appreciated that these embodiments represent examples to provide clear understanding of the technical contents of the invention, and the invention is not limited to these examples. The sprit and the scope of the invention, therefore, are limited solely by the scope of the appended claims.

This application corresponds to Japanese Patent Application No. 2002-368583 filed with the Japanese Patent Office on Dec. 19, 2002, the entire contents of which are incorporated herein by reference.

What is claimed is:

1. A reflection preventing film modifying apparatus for performing processing with respect to a substrate on which is formed a reflection preventing film preventing reflection of light within a particular wavelength range to change an optical characteristic of a predetermined region to be processed in the reflection preventing film by selectively modifying the region to be processed in the reflection preventing film, the apparatus comprising:
a substrate holding mechanism configured to hold a substrate to be processed;
a modifying light irradiating mechanism configured to irradiate modifying light capable of modifying the reflection preventing film toward the substrate held by the substrate holding mechanism; and
a processing position changing mechanism configured to change a processing position of the modifying light on the substrate by changing a relative position between an irradiation position of the modifying light from the modifying light irradiating mechanism and the substrate held by the substrate holding mechanism.

2. A reflection preventing film modifying apparatus according to claim 1, wherein:
the substrate to be processed is provided with an alignment mark, on an underlying layer of the reflection preventing film, used for alignment between the substrate and an exposure mask used when a photosensitive film formed on the reflection preventing film is exposed to a specific pattern through the use of light within the particular wavelength range: and
the apparatus further comprises a modifying position control apparatus that controls the processing position changing mechanism so that the irradiation position of the modifying light from the modifying light irradiating mechanism is matched with the region to be processed that encompasses the alignment mark.

3. A reflection preventing film modifying apparatus according to claim 2, further comprising:
an alignment mark position measuring mechanism configured to measure a position of the alignment mark provided on the substrate held by the substrate holding mechanism through the use of light within a wavelength range other than the particular wavelength range,
wherein the modifying position control apparatus controls the processing position changing mechanism based on a measuring result from the alignment mark position measuring mechanism.

4. A reflection preventing film modifying apparatus according to claim 1, further comprising:
an accumulated light quantity measuring mechanism configured to measure an accumulated quantity of light as to the modifying light irradiated to the substrate to be processed from the modifying light irradiating mechanism; and
a modifying light irradiation control apparatus configured to keep irradiating the modifying light from the modifying light irradiating mechanism toward the substrate until the accumulated quantity of light measured by the accumulated light quantity measuring mechanism reaches a predetermined quantity.

5. A reflection preventing film modifying apparatus according to claim 1, further comprising:
an observation optical system used to observe an irradiation region of the modifying light through the use of light within the particular wavelength range;
an image pick-up apparatus configured to detect an image to be observed through the observation optical system; and
a modifying light irradiation control apparatus configured to control irradiation of the modifying light by the modifying light irradiating mechanism based on an output signal from the image pick-up apparatus.

6. A reflection preventing film modifying apparatus according to claim 5, further comprising:
a contrast detecting circuit configured to detect contrast of an image obtained by the image pick-up apparatus,
wherein the modifying light irradiation control apparatus keeps irradiating the modifying light from the modifying light irradiating mechanism toward the substrate until the contrast detected by the contrast detecting circuit reaches a maximal or local maximal value, or until a time at which the contrast detected by the contrast detecting circuit is predicted to reach the maximal or local maximal value.

7. A reflection preventing film modifying method, comprising:
a step of preparing a substrate on which is formed a reflection preventing film preventing reflection of light within a particular wavelength range; and
a modifying light irradiating step of irradiating modifying light, capable of modifying the reflection preventing film, to a predetermined region to be processed on the substrate, thereby selectively changing an optical characteristic of the region to be processed in the reflection preventing film.

8. A reflection preventing film modifying method according to claim 7, further comprising:
a step of measuring an accumulated quantity of light as to the modifying light irradiated to the region to be processed,
wherein the modifying light irradiating step includes a step of keeping the modifying light being irradiated to the region to be processed until the accumulated quantity of light as to the modifying light reaches a predetermined quantity.

9. A reflection preventing film modifying method according to claim 7, further comprising:
a step of providing an observation optical system used to observe the region to be processed through the use of light within the particular wavelength range; and
a step of detecting an image to be observed through the observation optical system by an image pick-up apparatus,
wherein the modifying light irradiating step includes a step of keeping the modifying light being irradiated to the region to be processed until contrast of an image detected by the image pick-up apparatus reaches a maximal or local maximal value, or until a time at which the contrast is predicted to reach the maximal or local maximal value.
